(19) United States
(12) Patent Application Publication
(10) Pub. No.: US 2023/0195898 A1
(43) Pub. Date: Jun. 22, 2023

(54) BIOS BACKUP

(71) Applicant: HEWLETT-PACKARD DEVELOPMENT COMPANY, L.P., Spring, TX (US)

(72) Inventors: ROSILET RETNAMONI BRADUKE, Spring, TX (US); Weize LIU, Spring, TX (US); Rajesh A, SHAH, Spring, TX (US)

(73) Assignee: HEWLETT-PACKARD DEVELOPMENT COMPANY, L.P., Spring, TX (US)

(21) Appl. No.: 17/923,382

(22) PCT Filed: Jun. 24, 2020
(86) PCT No.: PCT/US2020/039361

§ 371 Date: Nov. 4, 2022

(51) Int. Cl. G06F 21/57; G06F 9/4401; G06F 11/14; H04L 9/32

(52) U.S. Cl. CPC G06F 21/572; G06F 9/4403; G06F 11/1417; G06F 21/575; H04L 9/3242; H04L 9/3247; G06F 2201/84; G06F 2221/034

(57) ABSTRACT

An example computing device including a processor, a first non-volatile memory to store a first basic input/output system (BIOS) image, a second non- volatile memory, and a controller. The controller Is to receive encrypted location and size information of the first BIOS image from the processor, verify the received encrypted location and size information of the first BIOS image, verify a signature of the first BIOS image in the first non-volatile memory, control a backup process of the first BIOS image to the second non-volatile memory, verify the signature of the backed up first BIOS image in the second non-volatile memory, and in response to a successful verification of the signature, send a message to the processor to cause the processor to perform a boot process using the first BIOS image from the first non-volatile memory.

### BACKGROUND

A computing device may include instructions to perform various startup functions of the computing device. These instructions may include Basic Input/Output System (BIOS) instructions. The BIOS instructions may initialize and test hardware of the computing device. The BIOS instructions may also load bootstrap code and/or an operating system (OS) from a memory device of the computing device. The BIOS instructions may be the subject of attacks by malware in the computing device or from an external device. As a result of an attack, the BIOS instructions may become compromised.

### BRIEF DESCRIPTION OF THE DRAWINGS

FIG. 1 is a block diagram of a configuration of a computing device, according to an example;

FIGS. 2A and 2B are block diagram of a configuration of a BIOS image, according to an example;

FIG. 2C is a diagram of encrypted location and size information of a BIOS image, according to an example;

FIG. 3 is a block diagram of initiating the backup process of the first BIOS image, according to an example;

FIG. 4 is a block diagram of an initial boot of the first BIOS image, according to an example;

FIG. 5 is a block diagram of a configuration of a controller, according to an example,

FIGS. 6A and 6B are block diagrams of operations performed by a controller when a program is executed by the controller, according to an example;

### DETAILED DESCRIPTION

Various examples of the disclosure will now be described in greater detail with reference to the accompanying drawings, wherein like reference characters denote like elements. Examples to be explained in the following may be modified and implemented in various different forms.

The term “processor” is to be interpreted broadly to include a central processing unit (CPU), a processing unit, an application-specific integrated circuit (ASIC), logic unit, or programmable gate array etc. The operations may all be performed by a single processor or divided amongst several processors.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

As used herein, a BIOS image may include BIOS instructions to perform various startup functions of a computing device.

As an example, a feature of a backup process is to back up a BIOS image to a private memory that may be securely and directly accessed from a controller. A host CPU is to read the entire BIOS image from a shared memory and send parts of the data to the controller at a time, for example 4 kilo bytes (KB) chunks of data at a time, to be written in the private memory. However, with this configuration, there is a risk that an attacker may interrupt the data transfer and inject malicious data. This would result in an invalid BIOS image being backed up to the private memory, which may result in a subsequent recovery to fail.

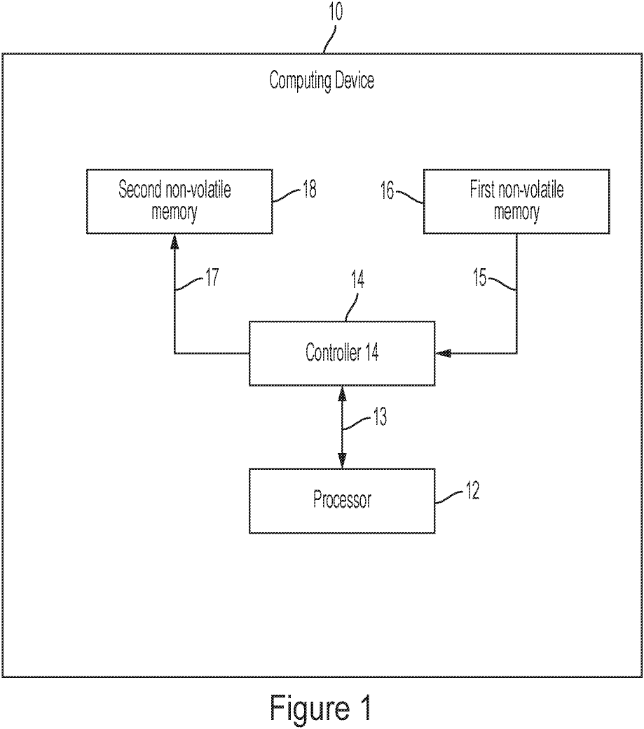

As an example, FIG. 1 is a block diagram of a computing device 10. The computing device 10 includes a processor 12, a controller 14, a first non-volatile memory 16, and a second non-volatile memory 18. The first non-volatile memory 16 may store a first BIOS image. The controller 14 is to receive encrypted location and size information of the first BIOS image from the processor 12, verify the received encrypted location and size information of the first BIOS image, verify a signature of the first BIOS image in the first non-volatile memory 16, control a backup process of the first BIOS image to the second non-volatile memory 18, verify the signature of the backed up first BIOS image in the second non-volatile memory 18, and in response to a successful verification of the signature, send a message to the processor 12 to cause the processor 12 to perform a boot process using the first BIOS image from the first non-volatile memory 16.

As an example, although the backup process is described for a BIOS image, the backup process may also be used to backup other firmware stored in the first non-volatile memory 16.

As an example, since the controller 14 verifies the encrypted location and size information of the first BIOS image, verifies a signature of the first BIOS image in the first non-volatile memory 16, then controls a backup process of the first BIOS image to the second non-volatile memory 18, and again verifies the signature of the backed up first BIOS image in the second non-volatile memory 18 to ensure there was no change during the backup process, the computing device 10 may help reduce or stop an intrusion attack from the processor 12 while the first BIOS image is being backed up. In addition, since the processor 12 is not involved in the backing up of the first BIOS image, this may also help reduce or stop an intrusion attack.

As an example, the controller 14 may be any type of controlling device capable of executing instructions. In addition, the controller 14 may be an Advanced RISC (reduced instruction set computing) Machine (ARM) based micro controller. As an example, the first non-volatile memory 16 may be a serial peripheral interface (SPI) chip. In addition, the second non-volatile memory 18 may also be an SPI chip.

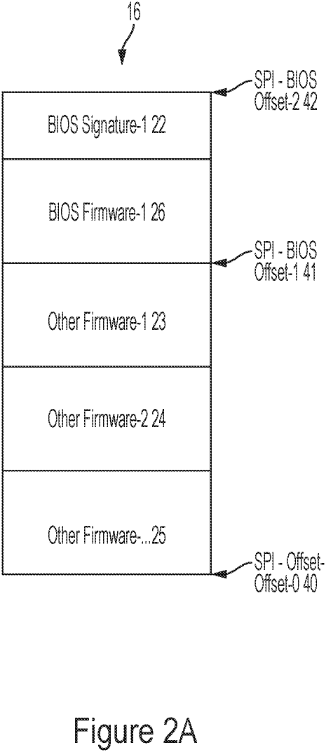

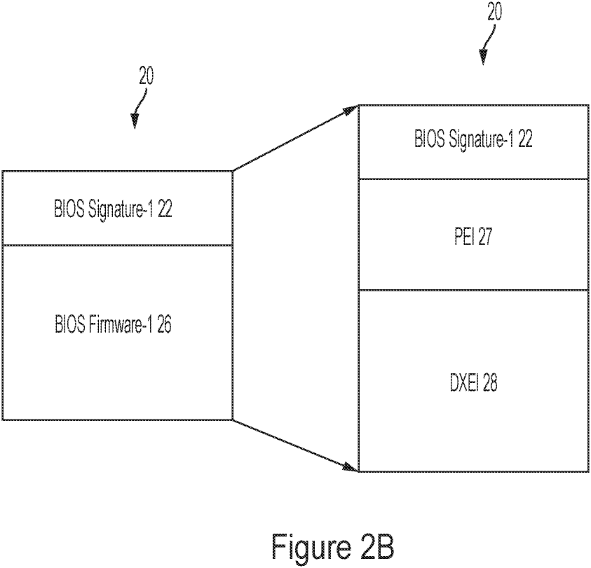

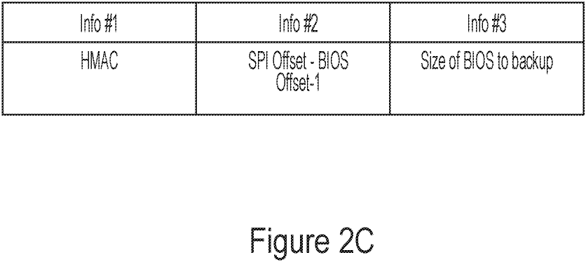

As an example, FIG. 2A is a block diagram of a first BIOS image 20 stored in the first non-volatile memory 16. The first BIOS image 20 may include a BIOS signature-1 22, BIOS-firmware-1 26, and the first non-volatile memory 16 may store other firmware-1 23, other firmware-2 24, and other firmware-... 25. The BIOS image 20 may include offsets, such as an SPI Offset - Offset-0 40, SPI - BIOS Offset-1 41, and SPI - BIOS Offset-2 42.

As an example, FIG. 2B is a block diagram of a first BIOS image 20. The first BIOS image 20 may be stored in the first non-volatile memory 16. The first BIOS image 20 may include a BIOS signature-1 22 and BIOS-firmware-1 26. The BIOS-firmware-1 26 may include a physical external interface (PEI) 27, which is an early stage of BIOS code, and may also include a driver execution environment interface (DXEI) 28, which is a later stage of BIOS code.

As an example, FIG. 2C shows an example of the encrypted location and size information of the first BIOS image 20. The info #1 may be the hash-based message authentication code (HMAC). The info #2 may be the location information of the first BIOS image 20 and may be located at the SPI -BIOS Offset-1 41. The info #3 is the size information of the first BIOS image 20. As an example, the size information may be determined by finding the difference between the SPI - BIOS Offset-1 41 and the SPI - BIOS Offset-2 42. The encrypted location and size information of the first BIOS image 20 received by the controller 14 may include info #1, info #2, and info #3.

Referring back to FIG. 1, the controller 14 may receive the encrypted location and size information of the first BIOS image 20 through a shared memory interface 13 with the processor 12. The controller 14 may verify the signature of the first BIOS image 20 through a shared interface 15, for example a shared SPI or a shared enhanced SPI (ESPI), with the first non-volatile memory 16. The controller 14 may control the backup process of the first BIOS image to the second non-volatile memory 18 through a direct access private interface 17, for example a private SPI, and then verify the signature of the backed up first BIOS image 20 in the second non-volatile memory 18 through the direct access private interface 17. The controller 14 may send a message to the processor 12 though the shared memory interface 13 to cause the processor 12 to perform a boot process using the first BIOS image 20 from the first non-volatile memory 16.

As an example, the encrypted location and size information of the first BIOS image 20 may be encrypted by the processor 12 with HMAC. The encrypted location and size information of the first BIOS image 20 may be encrypted by the processor 12 by other types of message authentication code encryptions and other encryption processes as well. The location information of the first BIOS image 20 may refer to an offset value through the shared interface 15 where the BIOS-firmware 26 starts. The size information of the first BIOS image 20 may refer to the size of the BIOS-firmware 26.

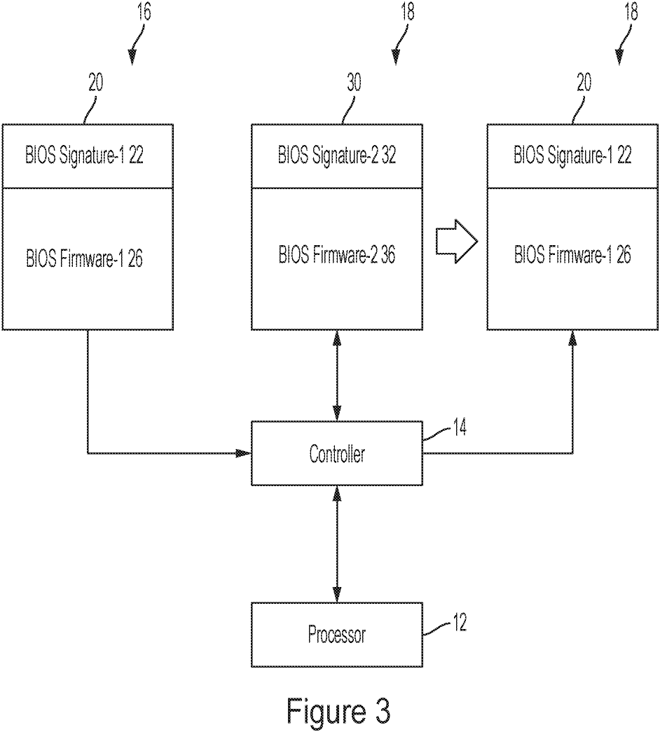

As an example, FIG. 3 is a block diagram of initiating the backup process of the first BIOS image 20 to the second non-volatile memory 18. The controller 14 compares a second BIOS image 30 in the second non-volatile memory 18 to the first BIOS image 20 in the first non-volatile memory 16 and determines whether the first BIOS image 20 is different than the second BIOS image 30. In response to determining the first BIOS image 20 in the first non-volatile memory 16 is different than the second BIOS image 30 in the second non-volatile memory 18, the controller 14 notifies the processor 12 to send the encrypted location and size information of the first BIOS image 20 to the controller 14 to initiate the backup process of the first BIOS image 20 to the second non-volatile memory 18.

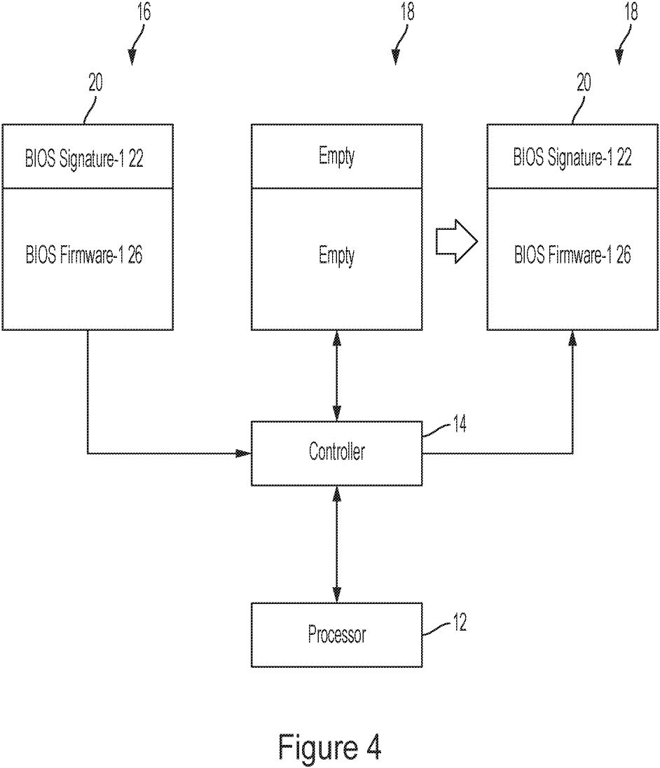

As an example, FIG. 4 is a block diagram of initiating the backup process of the first BIOS image 20 to the second non-volatile memory 18 during an initial boot of the first BIOS image 20. The controller 14 determines the second non-volatile memory 18 does not include a BIOS image. In response to determining the second non-volatile memory 18 does not include a BIOS image, the controller 14 notifies the processor 12 to send the encrypted location and size information of the first BIOS image 20 to the controller 14 to initiate the backup process of the first BIOS image 20 to the second non-volatile memory 18. After the backup process is completed, the first BIOS image 20 is stored in the second non-volatile memory 18.

As an example, using the configuration of the computing device 10 discussed above, the controller 14 may copy the entire first BIOS image 20 to the second non-volatile memory 18 during the backup process instead of sending parts of the first BIOS image 20 at a time.

As an example, the encrypted location and size information of the first BIOS image 20 may be encrypted by the HMAC. The processor 12 may encrypt the encrypted location and size information with the HMAC.The encrypted location and size information of the first BIOS image 20 may be encrypted by other types of message authentication code encryptions and other encryption processes as well. The location information of the first BIOS image 20 may refer to an offset value in the shared interface 15 where the BIOS-firmware 26 starts. The size information of the first BIOS image 20 may refer to the size of the BIOS-firmware 26.

As an example, the second non-volatile memory 18 may be a private memory with private direct accessibility for the controller 14.

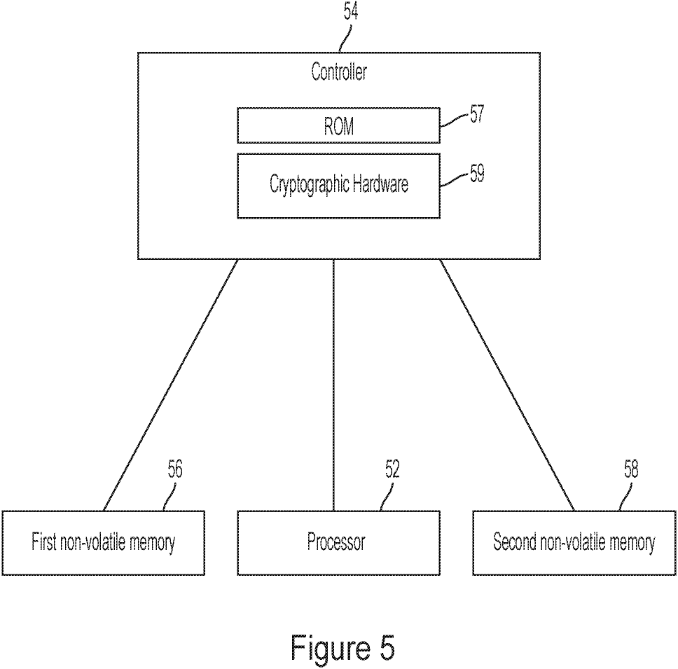

As an example, FIG. 5 is a block diagram of a controller 54, as an example of controller 14, coupled to a first non-volatile memory 56, a processor 52, and a second non-volatile memory 58. The processor 52 may send encrypted location and size information of a first BIOS image 20 located in the first non-volatile memory 56 to the controller 54 to cause the controller 54 to verify the first BIOS image 20 and to initiate a backup of the first BIOS image 20 to the second non-volatile memory 58. The encrypted location and size information may be sent though the shared memory interface 13.The processor 52 may receive a message from the controller 54 to initiate a boot using the first BIOS image 20 from the first non-volatile memory 56.

As an example, the processor 52 may receive the message from the controller 54 after the controller 54 verifies a signature of a backed up first BIOS image 20 in the second non-volatile memory 58. The controller 54 may verify the signature through the direct access private interface 17. The processor 52 may receive a notification from the controller 54 to send the encrypted location and size information of the first BIOS image 20 to the controller 54 after the controller 54 determines the first BIOS image 20 in the first non-volatile memory 56 is different than a second BIOS image 30 in the second non-volatile 58 or determines the second non-volatile memory 58 does not include a BIOS image.

As an example, and in reference to FIG. 2C, the location information may be an offset value indicating a storage address of the first BIOS image 20 in the first non-volatile memory 56.

As an example, the controller 54 may be any type of controlling device capable of executing instructions. In addition, the controller 54 may be an ARM based micro controller. As an example, the first non-volatile memory 56 may be an SPI chip. In addition, the second non-volatile memory 58 may also be an SPI chip.

As an example, the controller 54 may further include cryptographic hardware 59 to perform cryptographic computations, such as those used to verify the location and size of the first BIOS image 20 and to decrypt the encrypted location and size information using the HMAC. The cryptographic hardware 59 may be in the form of circuitry to perform cryptographic computations. The controller 54 may further include a read-only memory (ROM) 57. The ROM 57 may be used to store a boot loader and an encryption key.

As an example, the controller 54 may perform operations the same as or similarly to the controller 14 in FIGS. 1, 3, and 4.

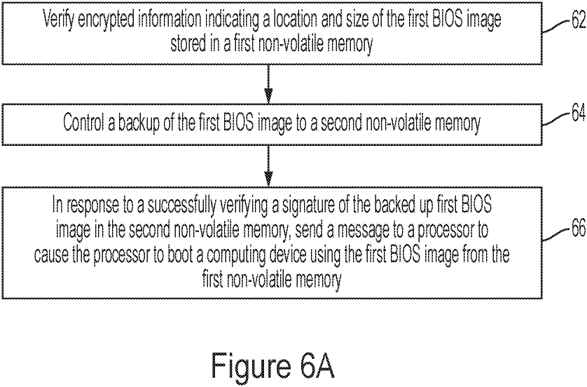

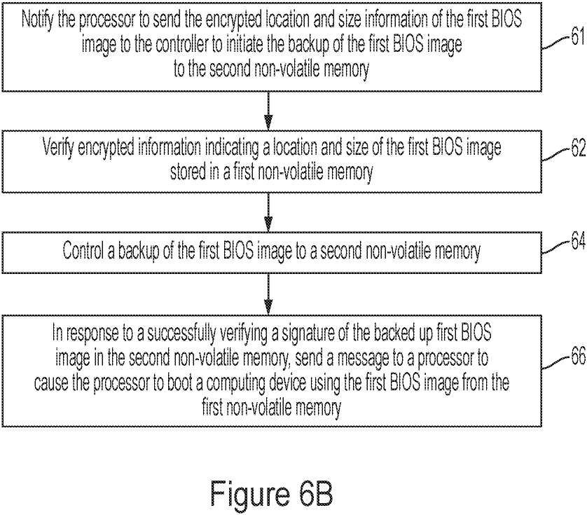

As an example, FIG. 6A is a block diagram of operations performed by a controller when a program is executed by the controller. The controller that executes the program may be similar to the controller 14 in FIGS. 1, 3, and 4 and may also be similar to the controller 54 in FIG. 5.

At operation 62, the controller 14 may include a non-transitory computer readable medium with instructions stored on the non-transitory computer readable medium. When the instructions are executed by the controller 14, at operation 62, the instructions cause the controller 14 to verify encrypted information indicating a location and size of the first BIOS image 20 stored in the first non-volatile memory 16. At operation 64, the instructions further cause the controller 14 to control a backup process of the first BIOS image 20 to the second non-volatile memory 18,.

At operation 66, the instructions further cause the controller 14 to, in response to successfully verifying a signature of the backed up first BIOS image 20 in the second non-volatile memory 18, send a message to a processor 12 to cause the processor 12 to boot a computing device 10 using the first BIOS image 20 from the first non-volatile memory 16.

As an example, FIG. 6B is a block diagram of operations performed by a controller when instructions are executed by the controller. Operations 62, 64 and 66 are similar to the operations performed in FIG. 6A. In operation 61, the instructions may further cause the controller 14 to, notify the processor 12 to send the encrypted location and size information of the first BIOS image 20 to the controller 14 to initiate the backup of the first BIOS image 20 to the second non-volatile memory 18. The encrypted location and size information may be sent though the shared memory interface 13.

The encrypted location and size information of the first BIOS image 20 may be received by the controller 14 from the processor 12. The processor 12 may encrypt the encrypted location and size information with the HMAC. The controller 14 may copy the entire first BIOS image 20 to the second non-volatile memory 18 during the backup.

The program of the controller 14 may be embodied in the form of instructions stored on a machine-readable medium, for example, in ROM 57 of controller 14, and executable by a processor and/or the cryptographic hardware 59. The program of the controller 14 may be written as computer programs and may be implemented in general-use digital computers or processors that execute the programs using a machine readable recording medium. Such machine readable instructions may be included on a non-transitory computer readable storage medium (including but not limited to non-volatile or volatile memory, disc storage, CD-ROM, optical storage, etc.) having computer readable program codes therein or thereon. Any type of non-volatile memory may be used. For example, the non-volatile memories 16, 18, 56, 58 may include different forms of non-volatile memories including semiconductor memory devices, such as read only memories, including erasable and programmable read-only memories (EPROMs), and electrically erasable and programmable read-only memories (EEPROMs); flash memories, solid-state drives.

When it is stated in the disclosure that one element is “connected to” or “coupled to” another element, the expression encompasses not only an example of a direct connection or direct coupling, but also a connection with another element interposed therebetween. Further, when it is stated herein that one element “includes” another element, unless otherwise stated explicitly, it means that yet another element may be further included rather than being excluded.

As used in the application, including in the claims, the word “or” is used in an inclusive manner. For example, “A or B” means any of the following: “A” alone, “B” alone, or both “A” and “B”.

The foregoing examples are merely examples and are not to be construed as limiting the disclosure. The disclosure can be readily applied to other types of apparatuses. Also, the description of the examples of the disclosure is intended to be illustrative, and not to limit the scope of the claims.

While the disclosure has been described with reference to the accompanying drawings, it is to be understood that the scope of the disclosure is defined by the claims described hereinafter and should not be construed as being limited to the above-described examples and/or drawings. It is to be clearly understood that improvements, changes, and modifications that are obvious to those skilled in the art are also within the scope of the disclosure as defined in the claims.

What is claimed is:

1. A computing device comprising:
a processor;
a first non-volatile memory to store a first basic input/output system (BIOS) image;
a second non-volatile memory; and
a controller to:
receive encrypted location and size information of the first BIOS image from the processor;
verify the received encrypted location and size information of the first BIOS image;
verify a signature of the first BIOS image in the first non-volatile memory;
control a backup process of the first BIOS image to the second non-volatile memory;
verify the signature of the backed up first BIOS image in the second non-volatile memory; and
in response to a successful verification of the signature, send a message to the processor to cause the processor to perform a boot process using the first BIOS image from the first non-volatile memory.

2. The computing device of claim 1, wherein the controller is to:
in response to determining the first BIOS image in the first non-volatile memory is different than a second BIOS image in the second non-volatile memory, notify the processor to send the encrypted location and size information of the first BIOS image to the controller to initiate the backup process of the first BIOS image to the second non-volatile memory.

3. The computing device of claim 1, wherein the controller is to:
in response to determining the second non-volatile memory does not include a BIOS image, notify the processor to send the encrypted location and size information of the first BIOS image to the controller to initiate the backup process of the first BIOS image to the second non-volatile memory.

4. The computing device of claim 1, wherein the controller is to copy an entire of the first BIOS image to the second non-volatile memory during the backup process.

5. The computing device of claim 1, wherein the processor encrypts the encrypted location and size information with a hash-based message authentication code (HMAC).

6. The computing device of claim 1, wherein the second non-volatile memory is a private memory with private accessibility for the controller.

7. A computing device comprising:
a first non-volatile memory to store a first basic input/output system (BIOS) image;
a second non-volatile memory;
a controller; and
a processor to:
send encrypted location and size information of the first BIOS image located in the first non-volatile memory to the controller to cause the controller to verify the first BIOS image and to initiate a backup of the first BIOS image to the second non-volatile memory; and
receive a message from the controller to initiate a boot using the first BIOS image from the first non-volatile memory.

8. The computing device of claim 7, wherein the processor is to receive the message from the controller after the controller verifies a signature of a backed up first BIOS image in the second non-volatile memory.

9. The computing device of claim 7, wherein the processor is to receive a notification from the controller to send the encrypted location and size information of the first BIOS image to the controller after the controller determines the first BIOS image in the first non-volatile memory is different than a second BIOS image in the second non-volatile memory or determines the second non-volatile memory does not include a BIOS image.

10. The computing device of claim 7, wherein the location information is an offset value indicating a storage address of the first BIOS image in the first non-volatile memory.

11. A non-transitory computer readable medium stored thereon instructions that, when executed by a controller, cause the controller to:
verify encrypted information indicating a location and size of the first BIOS image stored in a first non-volatile memory;
control a backup of the first BIOS image to a second non-volatile memory; and
in response to a successfully verifying a signature of the backed up first BIOS image in the second non-volatile memory, send a message to a processor to cause the processor to boot a computing device using the first BIOS image from the first non-volatile memory.

12. The non-transitory computer readable medium of claim 11, wherein the encrypted location and size information of the first BIOS image is to be received by the controller from the processor.

13. The non-transitory computer readable medium of claim 12, wherein the processor encrypts the encrypted location and size information with a hash-based message authentication code (HMAC).

14. The non-transitory computer readable medium of claim 11, wherein the controller is further caused to
notify the processor to send the encrypted location and size information of the first BIOS image to the controller to initiate the backup of the first BIOS image to the second non-volatile memory.

15. The non-transitory computer readable medium of claim 11, wherein the controller is to copy the entire first BIOS image to the second non-volatile memory during the backup.
